(19) United States
(12) Patent Application Publication
(10) Pub. No.: US 2010/0192083 A1
(43) Pub. Date: Jul. 29, 2010

(54) System and Method for Providing Compliance Monitoring

(76) Inventors: Robert Lang, Williamsport, PA (US); Russell Shanahan, State College, PA (US); Scott Marino, Williamsport, PA (US); Steve Valetta, Salisbury, MD (US)

Correspondence Address: DAVIDSON BERQUIST JACKSON & GOWDEY LLP, 4300 WILSON BLVD., 7TH FLOOR, ARLINGTON, VA, 22203, US

(21) Appl. No.: 12/504,873

(22) Filed: Jul. 17, 2009

Related U.S. Application Data
(60) Provisional application No. 61/146,702, filed on Jan. 23, 2009.

(51) Int. Cl. G06F 3/048

(52) U.S. Cl. 715/771; 715/808

(57) ABSTRACT

A system and method for the automatic identification of transportation regulatory violations on a unit-load device based on using selectable regulatory rule sets. An enforcement inspector may enter data during an inspection (e.g., during a roadside inspection) on regulated hazardous materials. Violations are identified at the detail level and at a higher level for consolidation reporting. Regulations can be cross-indexed for fast review.

### CROSS-REFERENCE TO RELATED APPLICATIONS

The present application is related to and claims priority to U.S. Provisional Patent Application Ser. No. 61/146,702, filed Jan. 23, 2009, the contents of which are incorporated herein by reference.

### FIELD OF INVENTION

The present invention is directed to a system and method for providing monitoring compliance with a set of regulations, and in one embodiment to a system and method for identifying transportation regulatory violations on a unit-load basis based on using a selectable set of regulations.

### DISCUSSION OF THE BACKGROUND

The effort to prevent violations of Hazardous Material Transportation regulations has been performed traditionally by humans using manuals and lookups. Prior attempts have focused on compliance from a point of view of how to properly identify or label cargo given a list of cargo to be transported. Attempts to automate this process have been made by ABF Freight, YRC, Conway Transportation (U.S. Pat. No. 6,888,475), Exis Technologies and others. However, such efforts were not done from an enforcement perspective nor were they aimed at finding violations in others' work product.

They also tended to not look at the load in total, except for segregation or to determine whether all of these goods can be on the same unit-load device (e.g., truck). The RegScan product HazMat Loader (2001) was an early attempt to address the whole load problem. This software, while a great improvement still required a highly trained inspector to review the results and determine if violations actually existed (e.g., when the device is being initially loaded or on the road as additional materials are loaded). The software could determine if segregation errors or incompatible goods loading had taken place, and, if so, provide a warning that the device is out of compliance and why.

In 2004, the Motor Cargo Tank Auditor was released, where the inspector made use of Yes/No responses from an inspector to record violations found by the inspector. Still the software was not able to find violations on its own, except when a wrong tank was selected for the commodity being shipped.

U.S. Pat. No. 6,688,475 describes how a computer makes use of rules to determine what material handling rules, placard, and safety rules to apply. Since fundamental inputs are the hazardous material transportation rules, it is normal to expect that elements of those rules must exist in any process that deals with compliance. Thus, references to using stored values and stored rules are common to both methods.

Accordingly, one object of the present invention is to automatically detect, identify, and report violations of the appropriate hazardous material transportation regulations.

Another object is to provide consistent application and evaluation of the applicable rulesets, including the automatic inclusion or exclusion of various rulesets as they become applicable or obsolete.

Another object of the invention is to allow learning of and re-application of exceptions to previously programmed or learned rules.

A further object of the invention is to identify whether there are violations, and, if so, what kind (e.g., conditional or explicit).

### BRIEF DESCRIPTION OF THE DRAWINGS

The following description, given with respect to the attached drawings, may be better understood with reference to the non-limiting examples of the drawings, wherein:

FIG. 1 is a screenshot of an exemplary interface for gathering information about materials loaded onto a unit-load device;

FIG. 2 is a screenshot of the exemplary interface of FIG. 1 receiving information on a particular type of bulk gas loaded onto a unit-load device;

FIG. 3 is a screenshot of the exemplary interface of FIG. 1 having received information on a particular type of bulk gas loaded onto a unit-load device;

FIG. 4 is a screenshot of the exemplary interface of FIG. 1 receiving information on a second particular type of bulk gas loaded onto a unit-load device;

FIG. 5 is a screenshot of the exemplary interface of FIG. 1 having received information on first and second types of bulk gas loaded onto a unit-load device;

FIG. 6 is a screenshot of an exemplary interface for indicating the placards (or other information) required to be in compliance when shipping specified materials on a unit-load device;

FIG. 7 is a screenshot of an exemplary interface for enabling an inspector to identify the placards (or other information) that are present on a unit-load device in order to have the system determine whether the unit-load device is in compliance with regulations;

FIG. 8 is a screenshot of an exemplary interface indicating that a unit-load device marked as specified by an inspector during an inspection is not in compliance based on the number and types of placards (or other information) shown;

FIG. 9 is a screenshot of other placard types in the exemplary interface of FIG. 7 for enabling an inspector to identify the placards (or other information) that are present on a unit-load device in order to have the system determine whether the unit-load device is in compliance with regulations;

FIG. 10 is a screenshot of an exemplary interface indicating that a unit-load device marked as specified by an inspector during an inspection is in compliance based on the number and types of placards (or other information) shown;

FIG. 11 is a screenshot of an exemplary interface for enabling an inspector to identify the markings (or other information) that are present on a unit-load device in order to have the system determine whether the unit-load device is in compliance with regulations;

FIG. 12 is a screenshot of an exemplary interface indicating the violation for a unit-load device marked as specified by an inspector during an inspection not being in compliance based on the number and types of placards (or other information) shown; and

FIG. 13 is a screenshot of an exemplary dialog box that requests additional information from a user before informing the user whether a set of conditions meet an exception.

### DISCUSSION OF THE PREFERRED EMBODIMENTS

According to the present invention, a computer can utilize the visual, audio, and textual information gathered about a load to determine if violations exist and what they are. By classifying and quantifying the marking, placards, and other information about a load and the unit-load device carrying the load, the correctness of the load can be determined. In one embodiment, the system can be programmed to learn additional rules as compared with the system's initial programming. This learning may utilize information about previously saved loads and feedback from the inspection process to identify why an inspector had to change or nullify an autonomously identified violation.

In one embodiment, the system and method detect violations in the transportation of hazardous materials (e.g., on highways, railways, airways). Compliance is measured against a set of regulations (e.g., the regulations contained in the Code of Federal Regulations for the corresponding mode of transportation (e.g., Title 49 or other regulations) or regulations such as the International TDG, IMDG, or IATA regulations). The process is based on capturing a large number of specific data points in a structured and defined manner. The relevant information can be captured using either a graphical user interface or a file-based interface (e.g., as might be used in a batch processing system). When using a graphical- or filed-based-interface, the system may utilize one or more fields of information (e.g., a unique identifier for a material) to automatically populate other fields (e.g., a textual name used for the material) to reduce data entry time while allowing increased readability/verifiability. In one embodiment of a file-based-interface, a batch processing system reads a file that can be in any one of a number of formats. For example, a file may contain fixed length or variable length information/fields in text or binary formats. In one embodiment, the file may also include structure information about the meaning of the data. For example, in an XML-based file embodiment, data elements may includes surrounding identifiers for each of the elements such as <UN>1006</UN> to identify a material number.

Determining if a violation has taken place or not requires evaluation of a series of rules, laws, and regulations for each commodity or hazardous materials division. The fact that you need to evaluate these regulatory rules is a given you cannot ignore. Unlike other software that tells the shipper what to do (e.g., place certain placards from a list on an appropriate number of sides of the device), the system described herein can also audit the unit-load device and the total load for compliance with the placards (or other information) that are shown on the unit-load device.

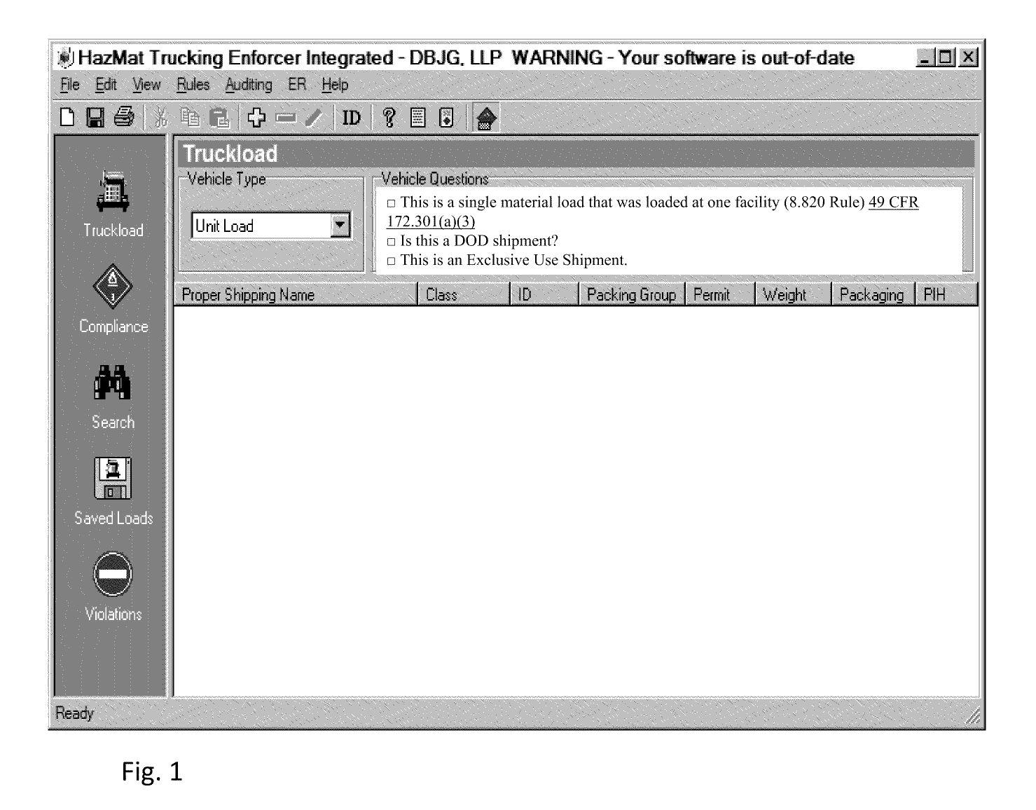

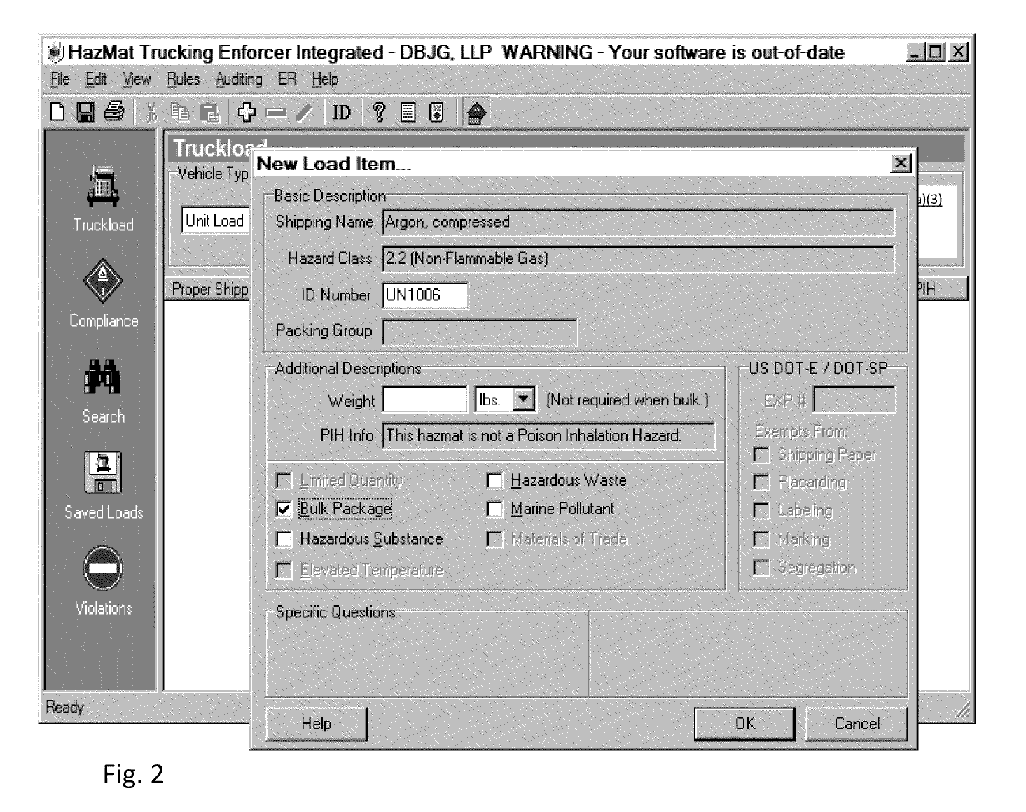

Turning to FIG. 1, as part of a data entry system (e.g., using a keyboard, mouse, barcode reader or RFID reader), a special-purpose main user interface (or another interface such as a web-browser based interface) running on a specially programmed, special-purpose or general purpose computer, can be used to specify that a new unit-load device is to be input. By selecting a control on the user interface (e.g., a “+” sign) or by utilizing a hot-key, the user may indicate to the system that a new material is to be added to the unit-load device. A user may then be prompted to input information about the new material, as shown in FIG. 2, for example, using a dialog box or other window control. The interface may make use of standard drop boxes, entry boxes, radio button and the like, along with hyper links to the regulations. Alternatively, in one embodiment, batch processing can be performed (e.g., to specify materials) without the need to use a graphical user interface for the adding process. Such a system could be used as part of an automated manifesting system (e.g., as part of an order management and delivery system that specifies outgoing orders for a particular unit load device).

In FIG. 2, the user has entered information indicating that the first material to be added to the load has a material number 1006 which identifies it as compressed Argon—a non-flammable gas. By entering the material number 1006, other known information about the material may automatically be loaded into the user interface. Such information may include the complete material number (e.g., “UN1006” instead of just 1006, and the shipping name and hazard class of the material). The user may also need to indicate other information about the shipping characteristics of the material besides the material number (e.g., whether the material is stored in bulk packaging or whether the material is considered a hazardous substance, hazardous waste or a marine pollutant). The user may further have to identify the weight of the material. In some cases, the user may be asked additional specific questions about the material once other information about the material and/or its shipping characteristics. (In a file-based interface, the same type of information as represented in FIG. 2 might be added to the system by processing an XML stream such as <LoadItem><UN>1006</UN><Bulk/></LoadItem>.)

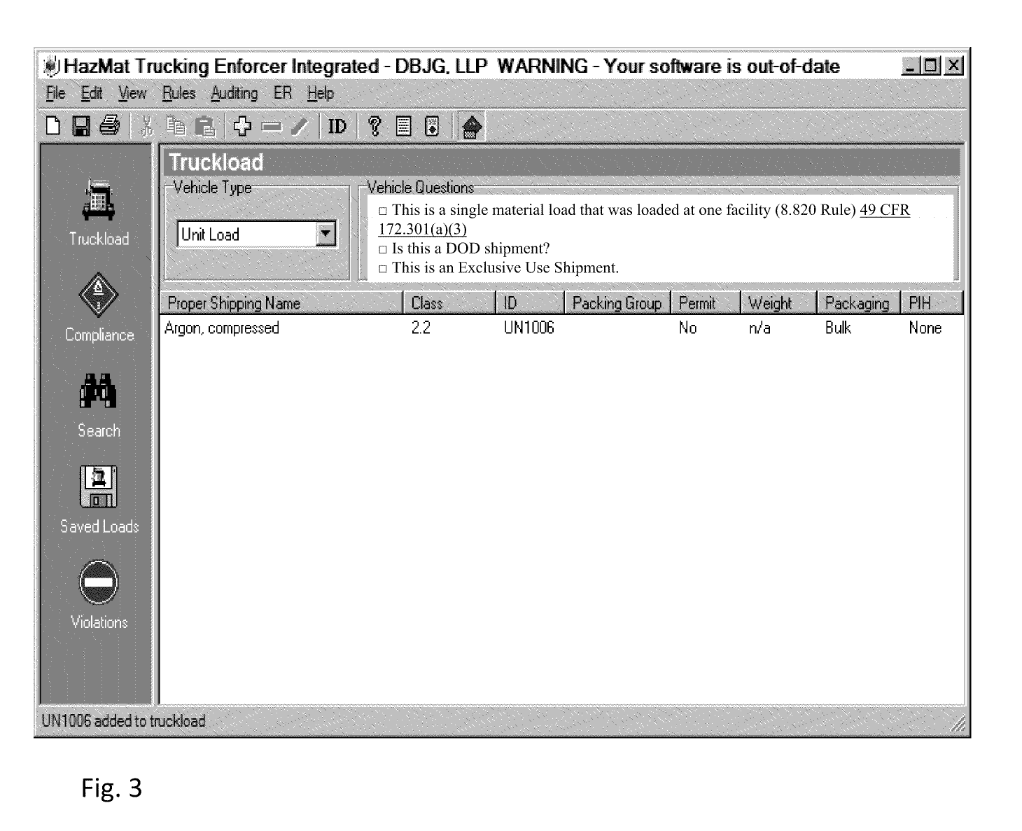

Once the user finishes entering all the required information and adding it to the unit-load device (using either a graphical- or file-based interface), the main user interface may be updated to reflect that the information was added properly, as shown in FIG. 3.

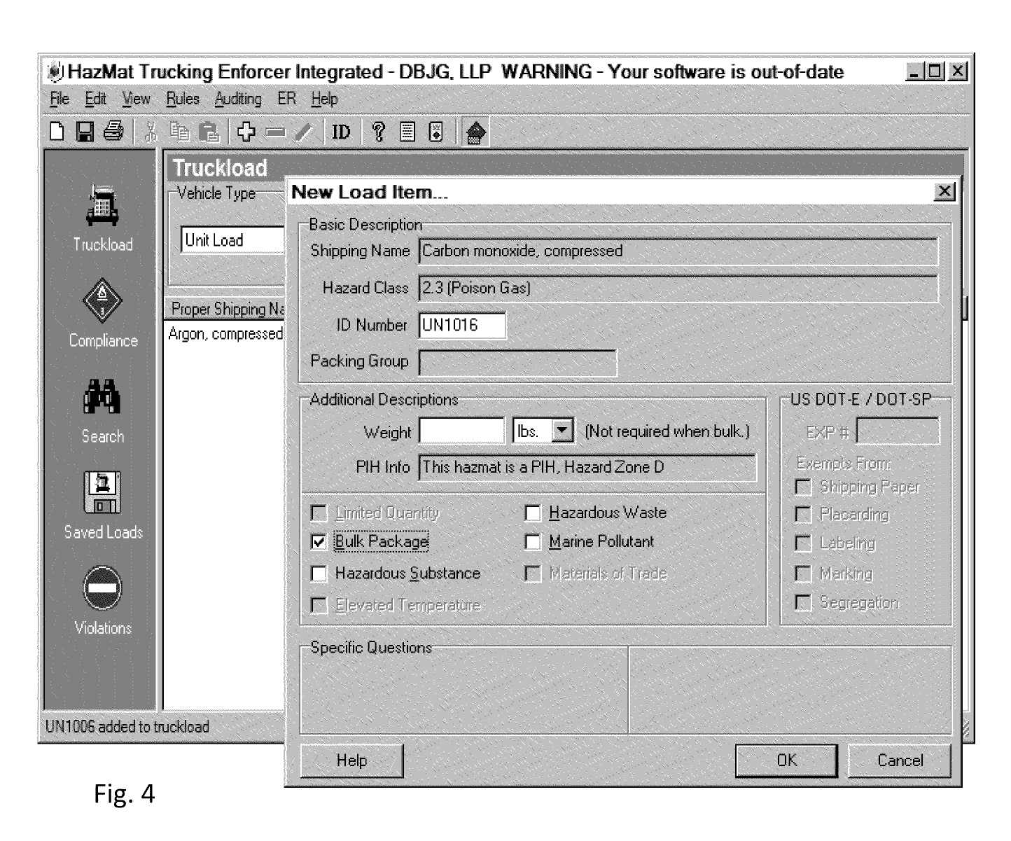

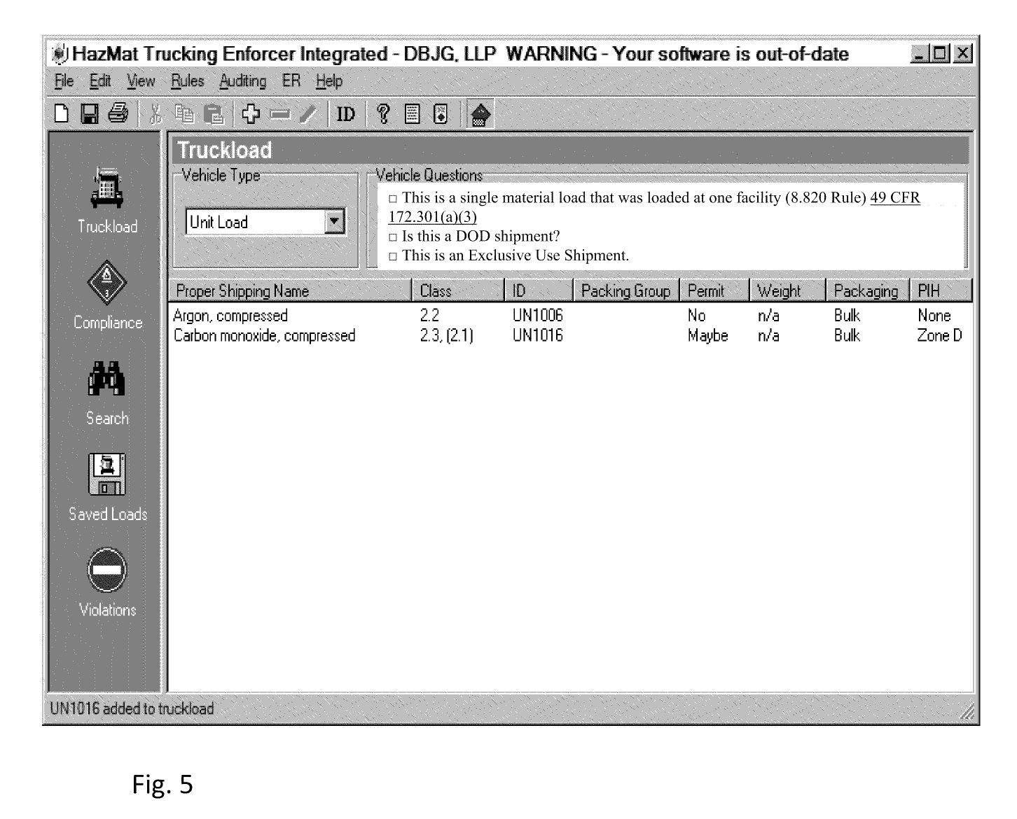

As shown in FIG. 4, this process can be repeated for other materials to be added to the unit-load device. For example, as shown in FIG. 4, a poisonous gas may be loaded onto the same unit-load device as was used with respect to FIGS. 2 and 3. As a result, as shown in FIG. 5, both the materials can be tracked by the system in a single unit-load device.

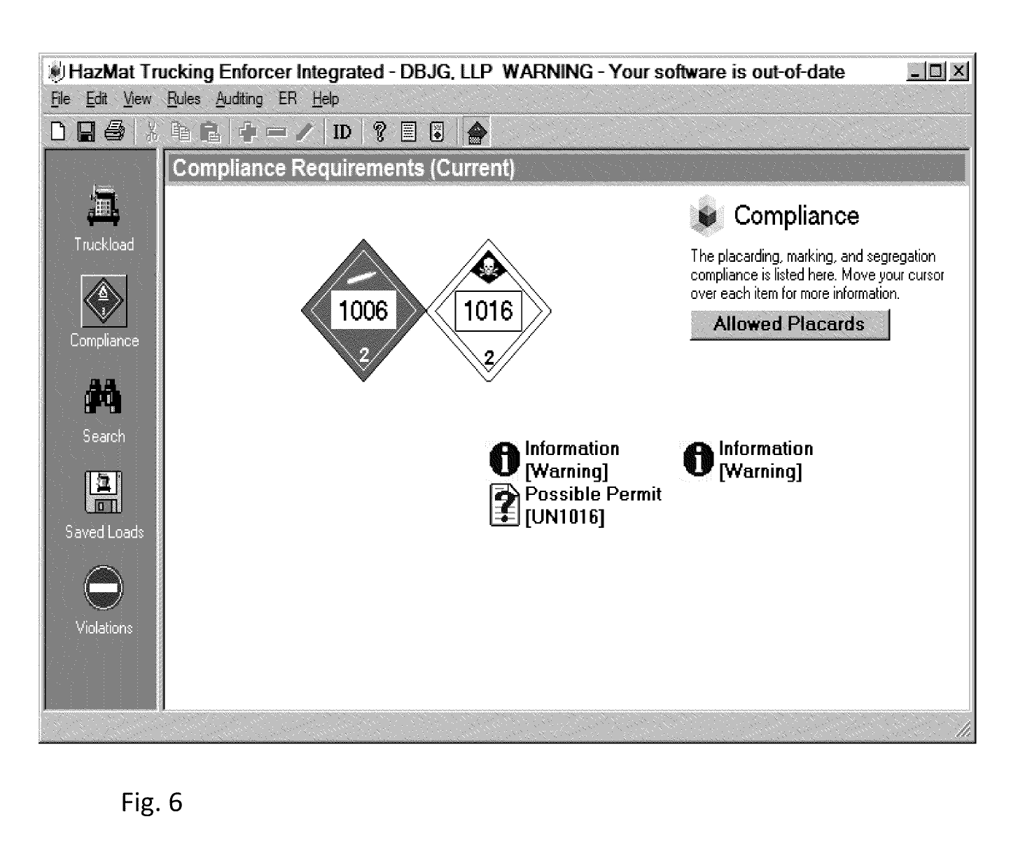

As shown in FIG. 6, by selecting a “compliance” option on the user interface of FIG. 1 (or by depressing a hot-key), the data analyzer of the system determines the shipping conditions that are required for the unit-load device to be in compliance with a selected set of regulations before leaving the loading area. Those shipping conditions may include at least one of a set of placards to be displayed, a set of markings to be displayed, a set of shipping papers to accompany the load and the type of packaging to be used in shipping the load. The system displays those conditions to the user.

However, in addition to utilizing the information about a unit-load device to enable the unit-load device to be in compliance with regulations before leaving a loading area, it is also possible to utilize information about a unit-load device to determine if the unit load device is in compliance after leaving a loading area (e.g., during a truck inspection). For example, an inspector (e.g., an enforcement officer, such as a police officer) may enter the information from a shipping paper/manifest of a unit-load device as described above. As used herein, the term “inspector” identifies a third-party other than the person or persons involved in loading and/or transporting the unit load on the unit load device, such as a person from a governmental regulatory or enforcement agency. The inspector may then select an auditing menu (or utilize a hot-key) to start the process of inputting information about a unit-load device so that the system can determine with the unit-load device is or is not in compliance with a set of regulations (e.g., whether the unit load device has the proper placards, markings, shipping papers or packaging).

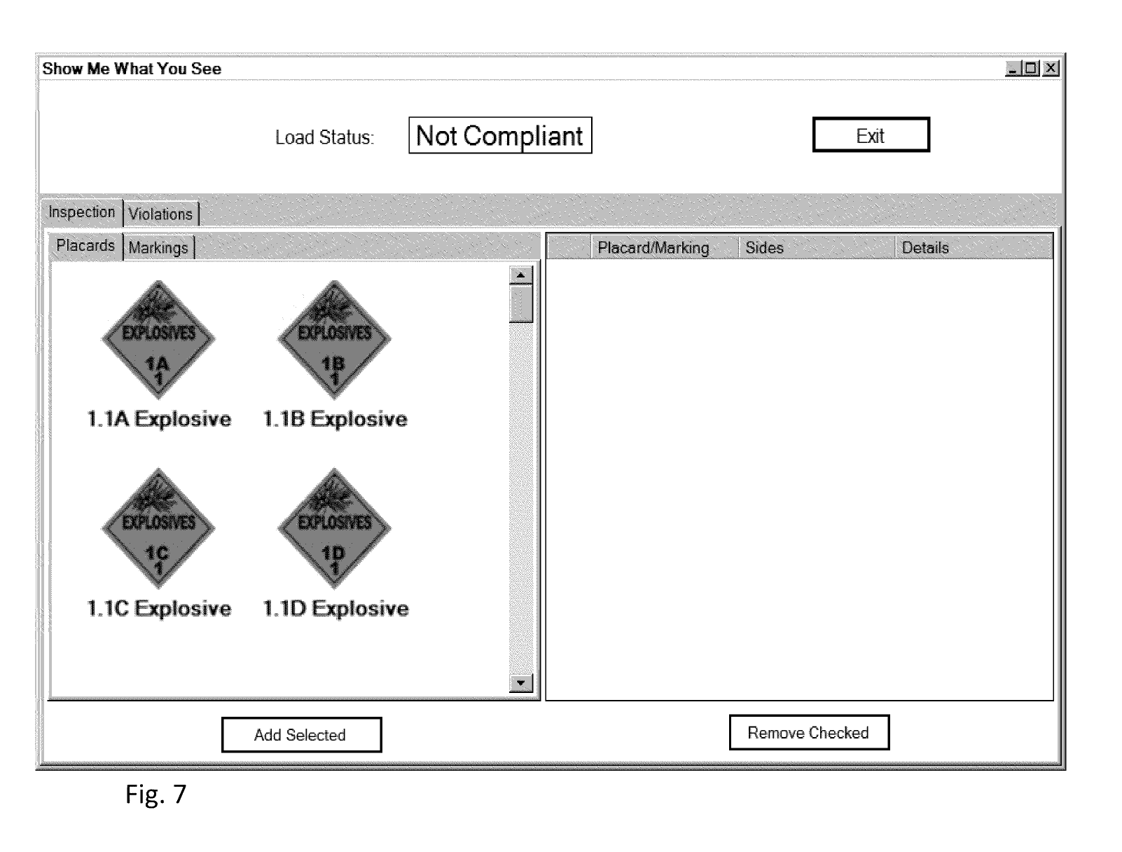

As shown in FIG. 7, an inspector may be provided with a visual set of placards to select from to identify what placards, if any, the inspector is seeing on the unit-load device during an inspection. (As used herein, “inspection” can be a scheduled inspection, such as at a weigh station, or an unscheduled inspection, such as during a traffic stop, and is synonymous with an “audit.”) This visual feedback system can be referred to as a “Show Me What You See” interface. Because of the number of possible placards, the interface may include a scrolling control as shown in FIG. 7 such that the inspector can look at each possible placard. In addition, the interface may also include filtering functions (not shown) which enable the system to only show a subset of the possible placards for faster viewing. In one embodiment, a filter includes a drop down box or other control that specifies the color of the placard to be added so that, for example, only placards with green are shown, thereby speeding up entry of the visually acquired information.

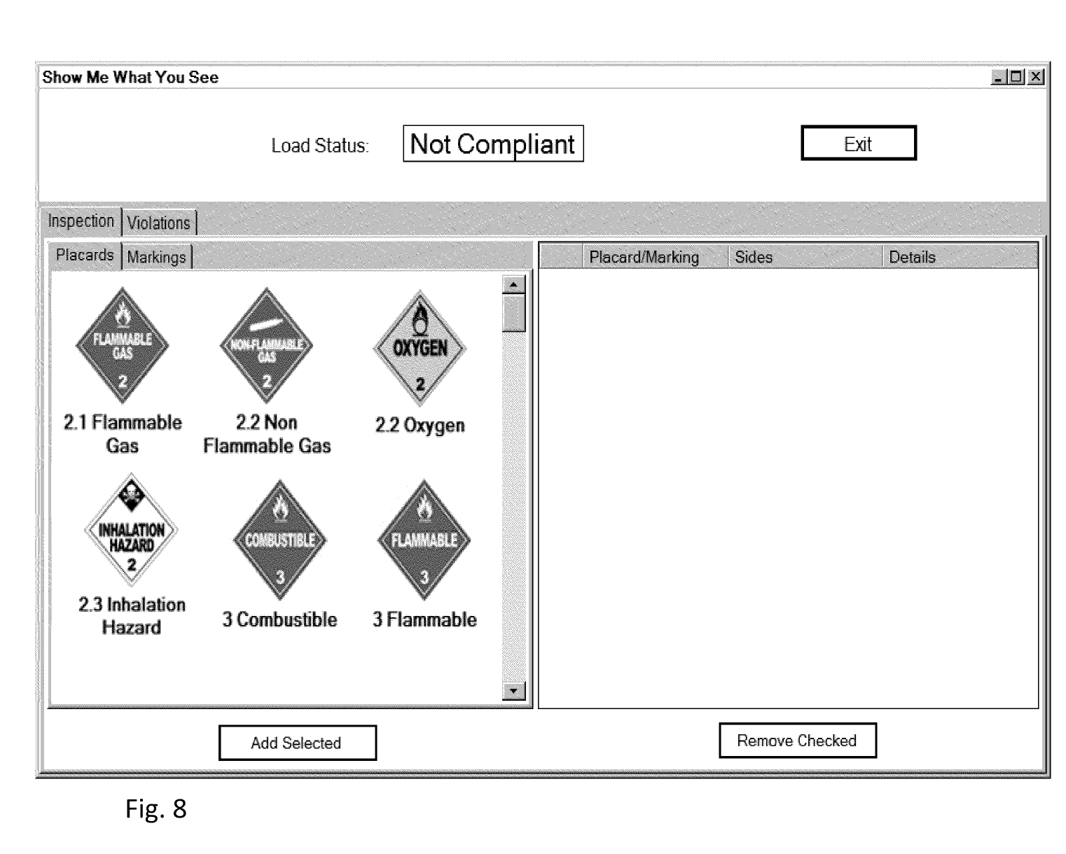

As shown in FIG. 8, once the placards that an inspector sees on a unit-load device have been specified to the system (including the number of sides that each placard is shown on the unit-load device), the system can determine whether or not the unit-load device is in compliance. In the above example, while the gases loaded are non-flammable and inhalation hazards, the unit-load device is not in compliance. This is because under the exemplary regulation, the unit-load device is not marked with sufficiently detailed placards as can be seen from a comparison of FIGS. 6 and 8.

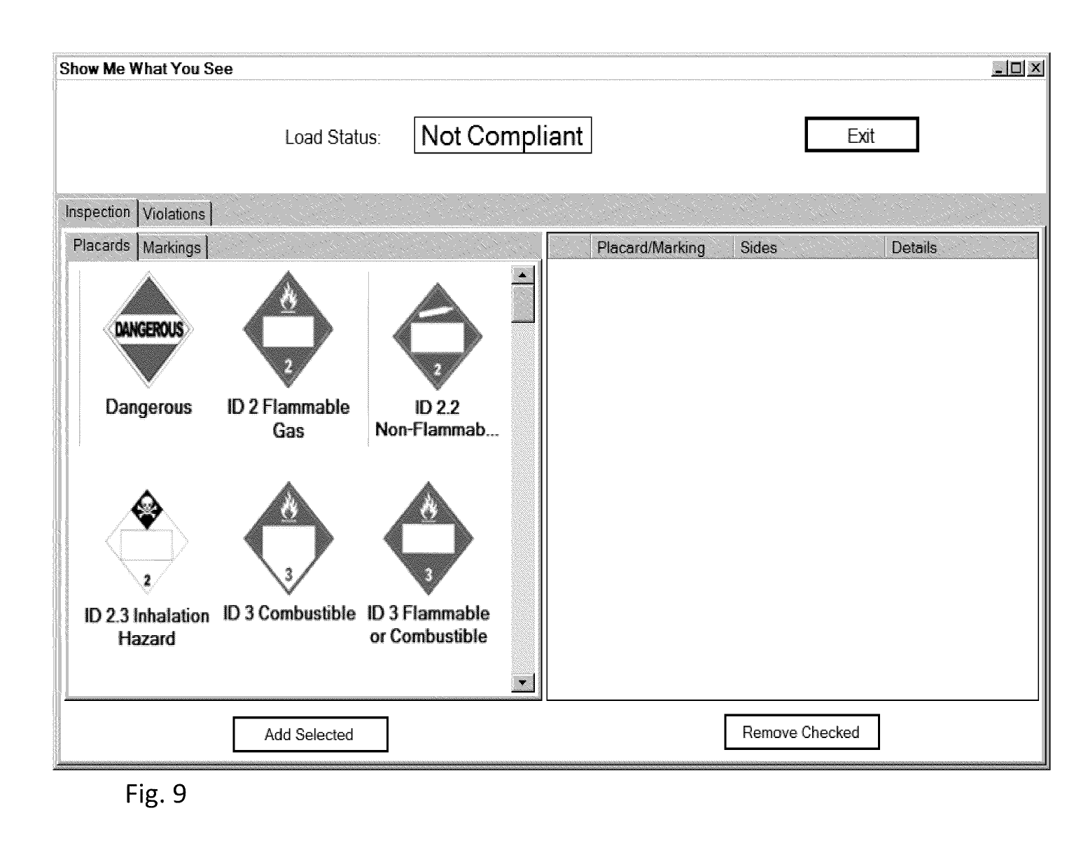

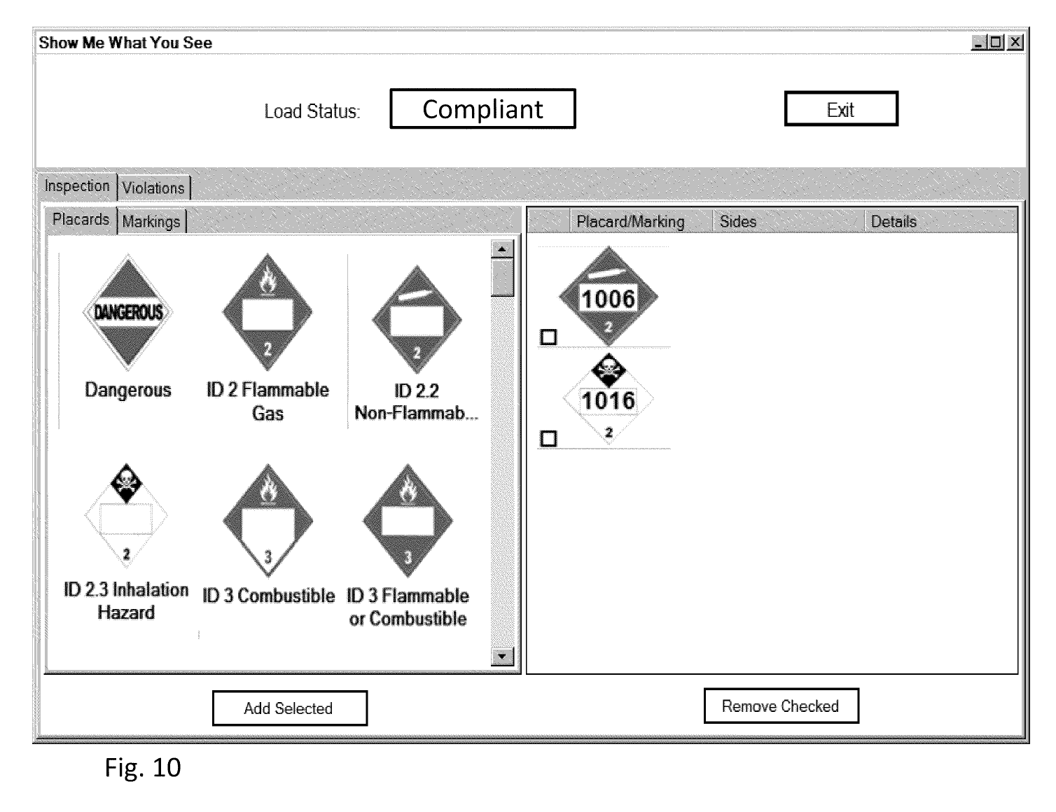

If, on the other hand, the unit-load device had been placarded with more specific placards (e.g., placards with material numbers on them), the inspector could have selected those placards from the list of available placards, as shown in FIG. 9. Because those placards require additional information to be added to the blank boxes, the system prompts the inspector to add the material number when the placard is added to the list of placards found on a unit-load device. Once a placard is selected the number, compatibility group (where required), physical location, and the ID number displayed on it (where used). As shown in FIG. 10, when the more detailed placards are used with the unit-load device, an inspector will be notified by the system that the unit-load device is in compliance. However, if the placard being added is illegal based on evaluation of the load that information is communicated immediately (e.g., in the form of a “Not Compliant” indicator).

In order to facilitate the selection of the correct placard and/or marking by the inspector, the placards and/or markings physically on the unit-load may be annotated with a small, non-intrusive unique identifier (in human or machine readable-form such as using a barcode or an RFID chip) that does not affect the readability of the placard and/or marking. The inspector may then enter the unique identifier of the corresponding placard or marking (either manually or using a electronic reader such as a barcode reader or an RFID reader). Alternatively, the shipping paper/manifest of the unit-load may include the unique identifier on it in human or machine-readable form.

As shown in FIGS. 8 and 10, the result of an inspection is a series of findings that are shown (e.g., no violation, definite violations, or conditional violations.) A conditional violation is one that takes additional information to determine if it is or is not a violation. An example of a conditional violation would be: does the specific commodity need to be indicated as a hazardous substance on the shipping papers. To answer this question the system needs to know “Does the transported package contain more than x amount of the specified hazardous substance?” The data needed to make this decision includes: (1) is the commodity on the Table A Hazardous Substance list, (2) is this a mixture; if so what is the percentage concentration, (3) how much of the commodity is contained in the package, (4) what is the net weight of each package and/or (5) What is the reporting threshold? Knowing the response to these 5 questions, potentially along with other information, allows a compliance determination to be made by the system. For example, the system may determine that if the commodity exceeded the threshold limit in any package then it needs to be marked as a hazardous substance.

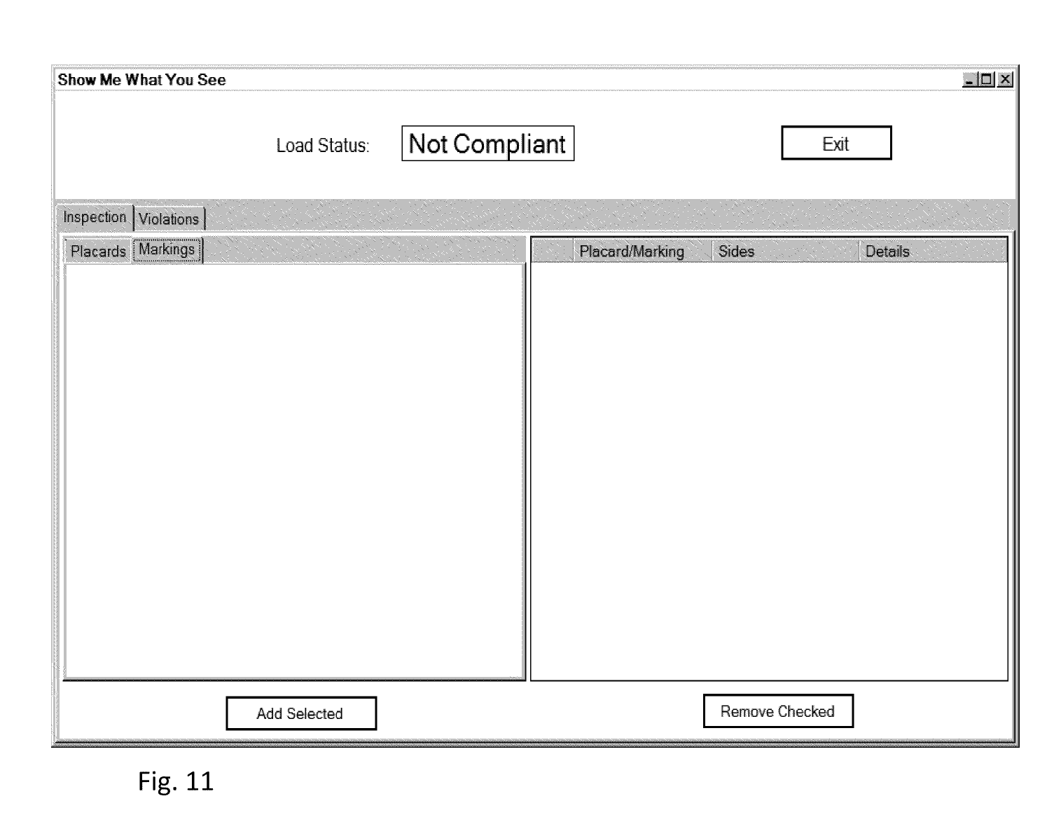

If the placards or markings shown on the truck are not in the list, then the Unknown Placard is shown. If the placard marked “Drive Safely” is shown, it should also be added. (This is an example of a placard that previously was allowed on a trailer which, due to a change in the regulations, is now no longer allowed to be shown.) In addition, other “markings” may also be required based on how a unit-load device is loaded. Thus, as shown in FIG. 11, an inspector may also add markings as part of the information used to determine whether a unit-load device is in compliance. Similarly, the inspector may identify to the system any shipping papers and/or special packing present which may needed to ensure compliance with the corresponding regulations.

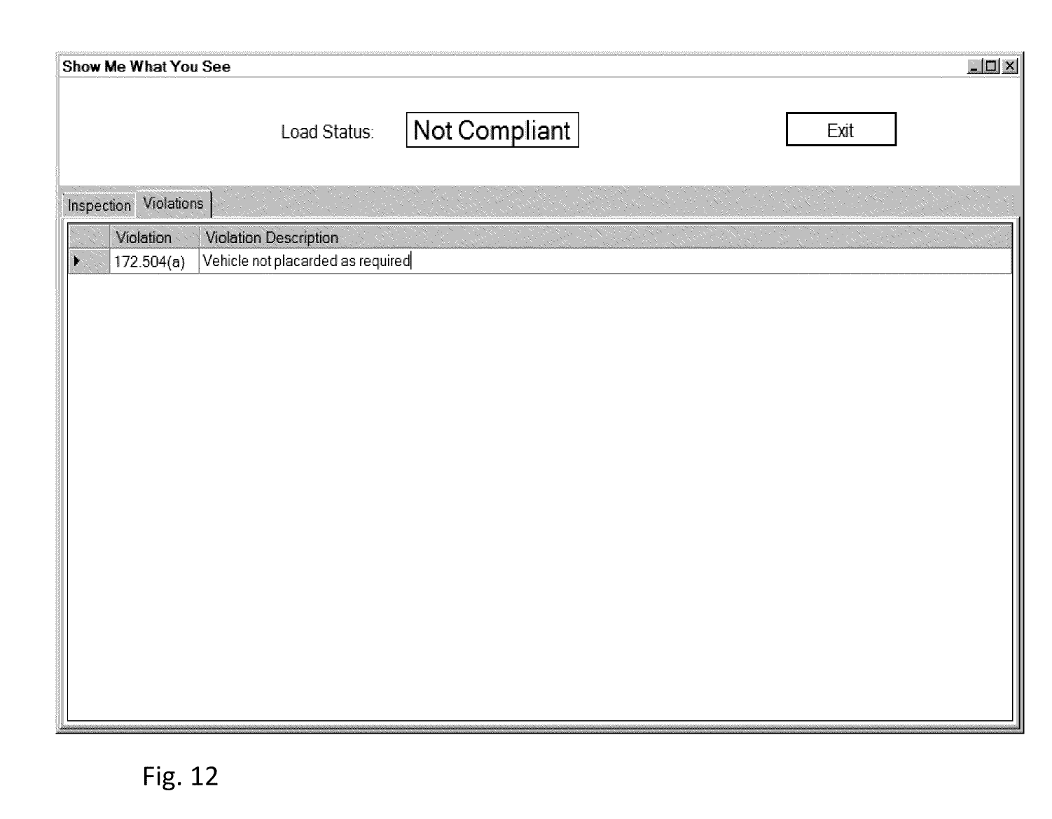

As violations are identified (e.g., as in FIG. 8), they are automatically added to the violations pane. Once a violation is flagged, the inspector using the violations pane (as shown in FIG. 12) can edit the details of the violation. All violations are automatically tagged based on specific coding rules for the reporting of violations. The final step is the reporting of violations against the appropriate enforcement report, driver, and carrier. In an alternate embodiment, the system may also identify for the inspector a penalty for failure to comply with a section of the set of regulations for which compliance was not found. Such a penalty could include that the unit load device must be kept out of service until the violation is corrected.

The Show-Me-What-You-See process can find, identify, and classify violations or the lack of violations of selected hazardous material transportation regulations as applied to the specified goods and the manner in which those goods are transported. The process includes the following steps: (1) Gather and consolidate available information sources, (2) ask for more information, (3) input gathered information, (4) analysis of available information versus selected rule set, (5) flag violation(s), (6) Review violations, (7) Send Violations to Data Gathering Program. The process may further include the ability to add annotations to the inspection record and/or save the inspection information for later review.

In addition to information on the placards and unit-load device described above, during the “Gather and consolidate available information sources” step, the system may need to collect information such as a Shipper's manifest, Copies of Permits/Letters/Authorizing documents, Prior Inspection decals and information from a driver. The system may also need unit-load name plate information and can track (a) Specific type of placard/marking, (b) Specific wording on placard/marking, (c) Specific numbers and words on placard/marking, (d) Specific location of placard/marking on unit-load device and (e) Number of same exact type of placard/marking on the unit-load device. Based on a visual inspection of the unit-load device, other information may also be needed and/or included, such as: (1) name plate information from each tank and cylinder carried on the unit-load device and (2) specification marks from each tank and cylinder carried on the unit-load device.

During the “ask for more information” step, an inspector may also gather, for entry into the system other shipment related information such as: (1) what other non-hazmat materials are on the load, (2) where the unit-load device was loaded, (3) whether this is a multimodal shipment, (4) whether this is a DOD shipment, (5) whether this shipment a highway route controlled shipment and (6) any other shipment characteristics. The system may also be informed whether there are any Special Exemption documents (e.g., DOT-E or DOT-SP documents).

Likewise, during the “Input gathered information” step, an inspector may enter a rule set to be inspected against and gather, for entry into the system, other shipment related information such as: (1) transit information (e.g., origin, destination, whether the trip is multimodal, whether the shipment is a special shipment (e.g., for DOD, highway route controlled, Agricultural Operations data or MOTS (Materials of Trade)), (2) whether special safety permits exist or are necessary. Additionally, the information relating to the manifest may be entered by the inspector and/or received electronically (e.g., by reading at least one machine-readable data identifier (e.g., a barcode or RFID chip), or by receiving an email or downloading a file containing the manifest). Information from the manifest may include data such as UN/NA Number (ID Number), Proper Shipping Name, Hazard Class, Packing Group, Hazard Zone, Weight, Marine Pollutant, Hazardous Substance, Limited Quantity, Bulk, Elevated Temperature, Hazardous Waste, Special Exemptions E or SP, Radiation TI. If an entered UN/NA number does not exist within the selected rule-set, then check to see if it is in another rule set and prompt the user as to whether to change rule sets if the wrong rule set was selected. If the rule set is correct and the UN/NA number does not exist, report an error.

Commodity specific Non HM Table information may also need to be included (e.g., 1. Compatibility Groups, 2. Gas, Solid, Liquid, 3. Cryogenic Liquid, 4. Internal Pressure, 5. Temperature, 6. Reactive, 7. Mixture Percentages (Calculate Total poundage of hazardous substance based on percentage), 8. Cigar Box Rule (Detonators), 9. Special Safety Permits, 10. Packaging contains residue). Having gathered the basic information, additional information may be necessary (e.g., number of pounds or gallons actually in a bulk shipment) and should be gathered and entered.

In the “analysis of available information versus selected rule set” step, the system determines whether the gathered and entered information indicates compliance with a selected rule set (e.g., Data in Hazmat Table 49 CFR 172.101 or other similar sections of other regulatory bodies). This may require look ups and comparisons of commodity-specific data in hazmat regulations, specified exemptions/exceptions and weights). It may also require a check of the load, its allowed packaging and its segregation. Segregation errors determine which item to eliminate based on: (i) Which category table it is listed on, (ii) What Hazard zone, and (iii) Order it was added to the load.

In the “flag violation(s)” step, various types of violations can be flagged. Violations can include, but are not limited to, (1) illegal placards and marking, (2) additional placards and markings utilized in violation of the hazardous, (3) needed placards or markings are missing, and (4) when a commodity cannot be transported in the manner it is being transported. In the “flag violations” step, the system determines if a unit-load device is found not to have the proper placards, markings or permits, for example, due to: (a) using an illegal method of transport of the commodity, (b) Selected Rule set restrictions, (c) Improper application of substitution, (d) Improper application of exemption or exception rules, and/or (e) Segregation. The system can also determine and record (1) whether additional placards and markings utilized in violation of the hazardous material were not on the allowed list, were not used in the correct quantities or did not meet the proper design standards and (2) when needed placards or markings are missing, whether the required marking or placard was (a) not found and/or (b) not found in the correct locations or with the correct quantity. The system can also determine and record when a commodity cannot be transported in the manner it is being transported such as when the required packaging is wrong, the shipping papers are wrong or generally the commodity is not in compliance with all requirements of the selected regulations

In the “Review violations” step, violations can be added or removed, for example as may be required when a rule set has not been updated to reflect a change in regulations. In one such case, an inspector may have received an update notice but may not have had time to upgrade the software of his/her inspection device (e.g., using a patch from the Internet, a removable storage medium or an externally connected device such as a USB device).

In the “Send Violations to Data Gathering Program” step, the system may upload (e.g., for accounting or regulatory purposes) information on the identified violation to a central repository. Such a repository may include the U.S. Federal Government's ASPEN system or other data gathering software.

As described above, the system may allow an inspector to add information to the inspection report or file. Such information may include notes and/or feedback questions for why the inspector had to change the identified system-generated violation(s) and/or why a violation was not flagged by the system. The information can be saved and transmitted in a secure manner to a remote host for feedback processing.

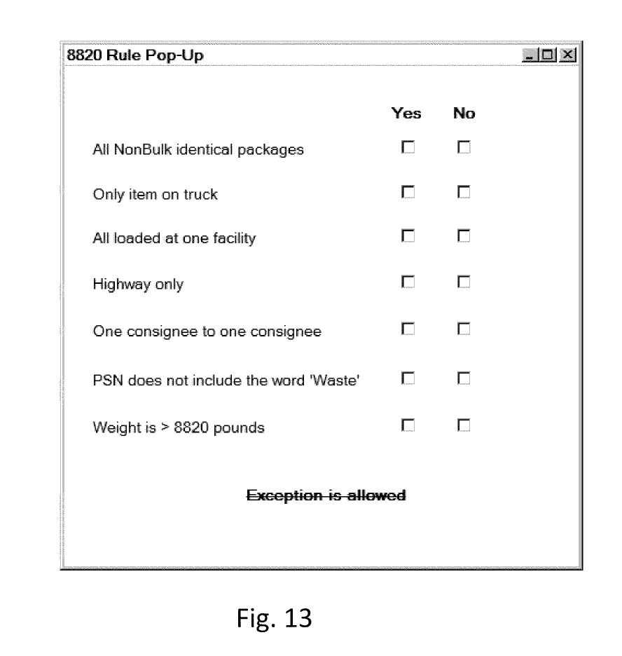

As described above, in some cases, the process to determine whether a load is in compliance is a multi-step process or a process that requires varying degrees of data entry. In order to facilitate the data entry process without cluttering the interface to accept all the different types of data that are possible, the interface may enable areas to have their functionality changed dynamically or may enable new areas to be added as might occur by displaying a dialog box (e.g., including user interface controls such as at least one data entry box, check box, radio button, and/or a yes/no box). For example, when a check-box is checked in a user interface, a series of user interface controls are presented to the user to walk the user through the compliance requirements. This process is iterative in that selecting a control in one pop-up may cause another dialog to pop-up. By utilizing this walk-through process, the system can verify that all information required for an exception is present before allowing a user to select that a particular material or load is actually subject to an exception. Alternatively, the interface may allow a user to test compliance with a multi-step process and then advise the user whether the system believes that the specified conditions indicate compliance. In this way, the user is ultimately able to manually control processing in case of a change in the regulations that have not yet been added to the system. An exemplary dialog box is shown in FIG. 13. That dialog box includes the text “Exception is allowed” which remains stricken though until the appropriate conditions are met.

The multi-step data entry process can be used for tracking compliance with Materials of Trade Exceptions (MOTS) and Agriculture Operations. Furthermore, below is an exemplary list of exceptions that can be processed by a multi-step exception checking process that utilizes iterative data collection.
1. Explosives and Compatibility Groups [173.52]
2. 8820 rule [172.301(a)(3)]
3. Extremely Hazardous Materials [385.403]
4. Required to Carry DOT-E & DOT-SP [107.101]
5. CERCLA Hazardous Materials [172.101 Appendix A] including (a) Non-Bulk per container calculations, (b) Bulk percentage calculations and (c) NOS
6. Marine Pollutants [172.101 Appendix B] including (a) Physical Properties Lookup, (b) Hazardous Material, (c) Extremely Hazardous Material, and (d) International Characterized
7. Small Quantity Exceptions [173.4 and 173.4(a)]
8. Agriculture Operations Exceptions [173.5]
9. Oil Field exceptions [173.5(a)]
10. Mobile Coolers exceptions [173.5(b)]
11. Materials of Trade Exceptions [173.6]
12. Government Operations [173.7]
13. Non-Specification Tanks [173.8]
14. Fumigated Unit Load [173.9]
15. Hazardous Waste Materials [173.12]
16. Specialized Exceptions [173.13]

In one embodiment, the system provides access to regulations within the data entry and/or analysis functions. Such access may be through the same interface as used in the data gathering step or may start another application to perform the review. For example, such a review could be initiated by clicking on a hyperlink in the original interface which then launches a web browser.

In accordance with a preferred embodiment of the invention, there is disclosed a process for the identification the correct visual information that must exist on shipping papers, the unit-load device, and even the packaging, including the type of packaging allowed. The above discussion is not intended to be limited to any particular type of transportation and may be used for transportation generally (e.g., trucking, train, aircraft and ships) under state, Federal or international regulations. The implementation of a system according to the description herein can be achieved using hardware and/or software. In one embodiment, the system is implemented on a hand-held or in-car computer system that allows compliance inspections to be conducted while an inspector is on the road.

While certain configurations of structures have been illustrated for the purposes of presenting the basic structures of the present invention, one of ordinary skill in the art will appreciate that other variations are possible which would still fall within the scope of the appended claims.

1. A system for determining non-compliance with a set of regulations during an inspection, the system comprising:
a data entry system for identifying (1) a type of materials being shipped as part of a unit load and (2) at least one shipping condition determined by an inspector to be associated with the unit load as part of shipping the unit load;
a data analyzer for determining if the at least one shipping condition determined by the inspector to be associated with the unit load as part of shipping the unit load renders the unit load not in compliance with the set of regulations; and
a user interface for alerting the inspector to at least one violation if the at least one shipping condition determined by the inspector to be associated with the unit load as part of shipping the unit load indicates non-compliance with the set of regulations.

2. The system as claimed in claim 1, wherein the set of regulations comprises a set of Federal trucking regulations.

3. The system as claimed in claim 1, wherein the at least one shipping condition comprises at least one of a set of placards and a set of markings determined by the inspector to be displayed on a unit load device transporting the unit load.

4. The system as claimed in claim 3, wherein the at least one set of placards and set of markings are selected graphically by the inspector from a graphical user interface of at least one of possible placards and possible markings.

5. The system as claimed in claim 3, wherein the at least one set of placards and set of markings are selected using a unique identifier for the corresponding placard or marking of the at least one set of placards and set of markings.

6. The system as claimed in claim 1, wherein the type of materials being shipped as part of the unit load is entered into the system from a shipping paper.

7. The system as claimed in claim 1, wherein the type of materials being shipped as part of the unit load is entered into the system by reading a file.

8. The system as claimed in claim 1, wherein the type of materials being shipped as part of the unit load is entered by reading a machine-readable data identifier.

9. The system as claimed in claim 1, wherein the data entry system comprises dynamically changing user interfaces for requesting additional information about a first type of material being shipped that is not requested for a second type of material.

10. The system as claimed in claim 1, wherein the user interface for alerting the inspector to the at least one violation comprises a user interface for identifying a section of the set of regulations for which compliance was not found.

11. The system as claimed in claim 1, wherein the system is implemented in at least one of a portable device and an in-car device.

12. The system as claimed in claim 1, wherein the at least one shipping condition comprises a set of shipping papers to accompany the unit load identifying hazardous materials within the unit load.

13. The system as claimed in claim 4, wherein the graphical user interface comprises a pop-up dialog for receiving information to be added to a bulk placard.

14. A method for determining non-compliance with a set of regulations during an inspection, the method comprising:
identifying (1) a type of materials being shipped as part of a unit load and (2) at least one shipping condition determined by an inspector to be associated with the unit load as part of shipping the unit load;
determining if the at least one shipping condition determined by the inspector to be associated with the unit load as part of shipping the unit load renders the unit load not in compliance with the set of regulations; and
a user interface for alerting the inspector to at least one violation if the at least one shipping condition determined by the inspector to be associated with the unit load as part of shipping the unit load indicates non-compliance with the set of regulations.

15. The method as claimed in claim 14, wherein the set of regulations comprises a set of Federal trucking regulations.

16. The method as claimed in claim 14, wherein the at least one shipping condition comprises at least one of a set of placards and a set of markings determined by the inspector to be displayed on a unit load device transporting the unit load.

17. The method as claimed in claim 16, wherein the at least one set of placards and set of markings are selected graphically by the inspector from a graphical user interface of at least one of possible placards and possible markings.

18. The method as claimed in claim 16, wherein the at least one set of placards and set of markings are selected using a unique identifier for the corresponding placard or marking of the at least one set of placards and set of markings.

19. The method as claimed in claim 14, wherein the type of materials being shipped as part of the unit load is entered from a shipping paper.

20. The method as claimed in claim 17, wherein the graphical user interface comprises a pop-up dialog for receiving information to be added to a bulk placard.
